(19) United States
(12) Patent Application Publication
(10) Pub. No.: US 2023/0236601 A1
(43) Pub. Date: Jul. 27, 2023

(54) CONTROL SYSTEM, CONTROL METHOD, AND COMPUTER READABLE MEDIUM

(71) Applicant: TOYOTA JIDOSHA KABUSHIKI KAISHA, Toyota-shi (JP)

(72) Inventors: Kei YOSHIKAWA, Nagoya-shi (JP); Shiro ODA, Anjo-shi (JP); Susumu SHIMIZU, Tokyo (JP); Takeshi MATSUI, Nissin-shi (JP)

(73) Assignee: TOYOTA JIDOSHA KABUSHIKI KAISHA, Toyota-shi (JP)

(21) Appl. No.: 18/074,649

(22) Filed: Dec. 5, 2022

(30) Foreign Application Priority Data
Jan. 11, 2022 (JP) 2022-002508

(51) Int. Cl. G05D 1/02; G05D 1/00; G06V 40/10; G06V 20/52; H04N 23/667

(52) U.S. Cl. CPC G05D 1/0246; G05D 1/0094; G05D 1/0212; G06V 20/52; G06V 40/10; H04N 23/667; G05D 2201/0206; G05D 2201/0209

(57) ABSTRACT

A control system is configured to control a system including a plurality of cameras installed in a facility, and perform a group classification process for recognizing a feature of a person photographed by the camera and classifying the person into a predetermined first or second group based on the feature. When there is or isn’t a person belonging to the first group, the control system selects a first operation mode and a second operation mode different from the first operation mode, respectively. When the control system selects the second operation mode, it performs the process so as to make either one of the number of cameras to be operated among the plurality of cameras and the number of cameras used as an information source in classification in the process among the plurality of cameras less than the number of cameras that are used when the first operation mode is selected.

### CROSS REFERENCE TO RELATED APPLICATIONS

This application is based upon and claims the benefit of priority from Japanese Patent Application No. 2022-002508, filed on Jan. 11, 2022, the disclosure of which is incorporated herein in its entirety by reference.

### BACKGROUND

The present disclosure relates to a control system, a control method, and a program.

Japanese Unexamined Patent Application Publication No. 2021-86199 discloses a control system for controlling a mobile robot moving in a facility.

### SUMMARY

It should be noted that monitoring systems for monitoring people have been introduced in various facilities such as hospitals. In the case where such a monitoring system is used in a hospital, there are, for example, two situations, i.e., a situation in which both people who work in the hospital such as hospital staff and people who do not work at the hospital such as visitors and patients are present, and a situation in which only people who work in the hospital such as hospital staff are present. However, in such a monitoring system, when monitoring is performed without distinguishing between these situations, the monitoring system is always subject to a certain processing load.

Therefore, it is desired to be able to flexibly change the processing load according to the situation and thereby to reduce the power consumption. Note that the above-described problem cannot be solved by the technology disclosed in Japanese Unexamined Patent Application Publication No. 2021-86199.

The present disclosure has been made in order to solve the above-described problem, and an object thereof is to provide a control system, a control method, and a program capable of, when controlling a system including a plurality of cameras installed in a facility, flexibly changing a processing load according to a situation and thereby reducing power consumption.

A first exemplary aspect is a control system configured to: perform system control for controlling a system including a plurality of cameras installed in a facility; and perform a group classification process for recognizing a feature of a person photographed by the camera and classifying the person into a predetermined first group or a predetermined second group based on the feature, in which in the system control, the control system selects a first operation mode when there is a person belonging to the first group, and selects a second operation mode different from the first operation mode when there is no person belonging to the first group, and when the control system selects the second operation mode, the control system performs the group classification process so as to make either one of the number of cameras to be operated among the plurality of cameras and the number of cameras used as an information source in classification in the group classification process among the plurality of cameras less than the number of cameras that are used when the first operation mode is selected. In this way, it is possible to, when controlling a system including a plurality of cameras installed in a facility, change a processing load according to a situation, and thereby to reduce power consumption.

In the system control, the plurality of cameras may be controlled so that the plurality of cameras are operated when the first operation mode is selected, and operations of the plurality of cameras except that of a first camera may be stopped when the second operation mode is selected. In this way, in the second operation mode, it is possible to reduce the processing load in a state in which at least the first camera necessary for monitoring is in operation.

The first camera may include a camera provided at a position for monitoring a security gate in the facility. In this way, in the second operation mode, it is possible to reduce the processing load in a state in which at least the first camera installed in a section where monitoring is necessary for security is in operation.

The system control may include control of a mobile robot configured to autonomously move in a predetermined area inside the facility; the camera may be provided at a position away from a surface on which the mobile robot travels so as to photograph a periphery of the traveling mobile robot; and in the system control, the plurality of cameras may be controlled so that the camera that functions as the first camera is changed according to a traveling position of the mobile robot. In this way, it is also possible to monitor the mobile robot, and to reduce, in the case of the second operation mode, the processing load in a state in which at least the first camera installed near the mobile robot is in operation.

The system control may include control of a mobile robot configured to autonomously move in a predetermined area inside the facility; and the camera may be provided at a position away from a surface on which the mobile robot travels so as to photograph a periphery of the traveling mobile robot. In this way, it is also possible to monitor the mobile robot.

In the group classification process, the person may be classified according to a feature of clothing of the person or according to whether or not the person carries a predetermined article. In this way, it is possible to easily classify a person.

A second exemplary aspect is a control method including: performing system control for controlling a system including a plurality of cameras installed in a facility; and performing a group classification process for recognizing a feature of a person photographed by the camera and classifying the person into a predetermined first group or a predetermined second group based on the feature, in which in the system control, a first operation mode is selected when there is a person belonging to the first group, and a second operation mode different from the first operation mode is selected when there is no person belonging to the first group and when the second operation mode is selected, the group classification process is performed so that either one of the number of cameras to be operated among the plurality of cameras and the number of cameras used as an information source in classification in the group classification process among the plurality of cameras is made less than the number of cameras that are used when the first operation mode is selected. In this way, it is possible to, when controlling a system including a plurality of cameras installed in a facility, change a processing load according to a situation, and thereby to reduce power consumption.

In the system control, the plurality of cameras may be controlled so that the plurality of cameras are operated when the first operation mode is selected, and operations of the plurality of cameras except that of a first camera may be stopped when the second operation mode is selected. In this way, in the second operation mode, it is possible to reduce the processing load in a state in which at least the first camera necessary for monitoring is in operation.

The first camera may include a camera provided at a position for monitoring a security gate in the facility. In this way, in the second operation mode, it is possible to reduce the processing load in a state in which at least the first camera installed in a section where monitoring is necessary for security is in operation.

The system control may include control of a mobile robot configured to autonomously move in a predetermined area inside the facility; the camera may be provided at a position away from a surface on which the mobile robot travels so as to photograph a periphery of the traveling mobile robot; and in the system control, the plurality of cameras may be controlled so that the camera that functions as the first camera is changed according to a traveling position of the mobile robot. In this way, it is also possible to monitor the mobile robot, and to reduce, in the case of the second operation mode, the processing load in a state in which at least the first camera installed near the mobile robot is in operation.

The system control may include control of a mobile robot configured to autonomously move in a predetermined area inside the facility, and the camera may be provided at a position away from a surface on which the mobile robot travels so as to photograph a periphery of the traveling mobile robot. In this way, it is also possible to monitor the mobile robot.

In the group classification process, the person may be classified according to a feature of clothing of the person or according to whether or not the person carries a predetermined article. In this way, it is possible to easily classify a person.

A third exemplary aspect is a program for causing a computer to perform a control method, the control method including: performing system control for controlling a system including a plurality of cameras installed in a facility; and performing a group classification process for recognizing a feature of a person photographed by the camera and classifying the person into a predetermined first group or a predetermined second group based on the feature, in which in the system control, a first operation mode is selected when there is a person belonging to the first group, and a second operation mode different from the first operation mode is selected when there is no person belonging to the first group, and when the second operation mode is selected, the group classification process is performed so that either one of the number of cameras to be operated among the plurality of cameras and the number of cameras used as an information source in classification in the group classification process among the plurality of cameras is made less than the number of cameras that are used when the first operation mode is selected. In this way, it is possible to, when controlling a system including a plurality of cameras installed in a facility, change a processing load according to a situation, and thereby to reduce power consumption.

In the system control, the plurality of cameras may be controlled so that the plurality of cameras are operated when the first operation mode is selected, and operations of the plurality of cameras except that of a first camera may be stopped when the second operation mode is selected. In this way, in the second operation mode, it is possible to reduce the processing load in a state in which at least the first camera necessary for monitoring is in operation.

The first camera may include a camera provided at a position for monitoring a security gate in the facility. In this way, in the second operation mode, it is possible to reduce the processing load in a state in which at least the first camera installed in a section where monitoring is necessary for security is in operation.

The system control may include control of a mobile robot configured to autonomously move in a predetermined area inside the facility; the camera may be provided at a position away from a surface on which the mobile robot travels so as to photograph a periphery of the traveling mobile robot, and in the system control, the plurality of cameras may be controlled so that the camera that functions as the first camera is changed according to a traveling position of the mobile robot. In this way, it is also possible to monitor the mobile robot, and to reduce, in the case of the second operation mode, the processing load in a state in which at least the first camera installed near the mobile robot is in operation.

The system control may include control of a mobile robot configured to autonomously move in a predetermined area inside the facility; and the camera may be provided at a position away from a surface on which the mobile robot travels so as to photograph a periphery of the traveling mobile robot. In this way, it is also possible to monitor the mobile robot.

In the group classification process, the person may be classified according to a feature of clothing of the person or according to whether or not the person carries a predetermined article. In this way, it is possible to easily classify a person.

According to the present disclosure, it is possible to provide a control system, a control method, and a program capable of, when controlling a system including a plurality of cameras installed in a facility, flexibly changing a processing load according to a situation and thereby reducing power consumption.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a conceptual diagram for explaining an example of an overall configuration of a conveyance system using a mobile robot into which a control system according to an embodiment can be incorporated;

FIG. 2 is a control block diagram of the conveyance system shown in FIG. 1;

FIG. 3 is a schematic diagram showing an example of a mobile robot;

FIG. 4 is a control block diagram showing a control system for mode control;

FIG. 5 is a table for explaining an example of staff information;

FIG. 6 is a table for explaining an example of mode information;

FIG. 7 is a flowchart showing an example of a control method according to an embodiment;

FIG. 8 is a diagram for explaining an embodiment of mode control;

FIG. 9 is a diagram for explaining an embodiment of mode control;

FIG. 10 is a flowchart for explaining another example of the control method according to the embodiment; and

FIG. 11 shows an example of a hardware configuration of an apparatus.

### DESCRIPTION OF EMBODIMENTS

The present disclosure will be described hereinafter through embodiments of the disclosure, but the invention according to the claims is not limited to the below-shown embodiments. Further, all the components/structures described in an embodiment are not necessarily essential as means for solving the problem.

### (General Configuration)

A control system according to this embodiment performs is a system capable of monitoring people by performing system control for controlling a system including a plurality of cameras installed in a facility, and performing a group classification process for classifying persons. The system control can be performed by a system control unit provided in the control system, and the group classification process can be performed by a group classification unit provided in the control system.

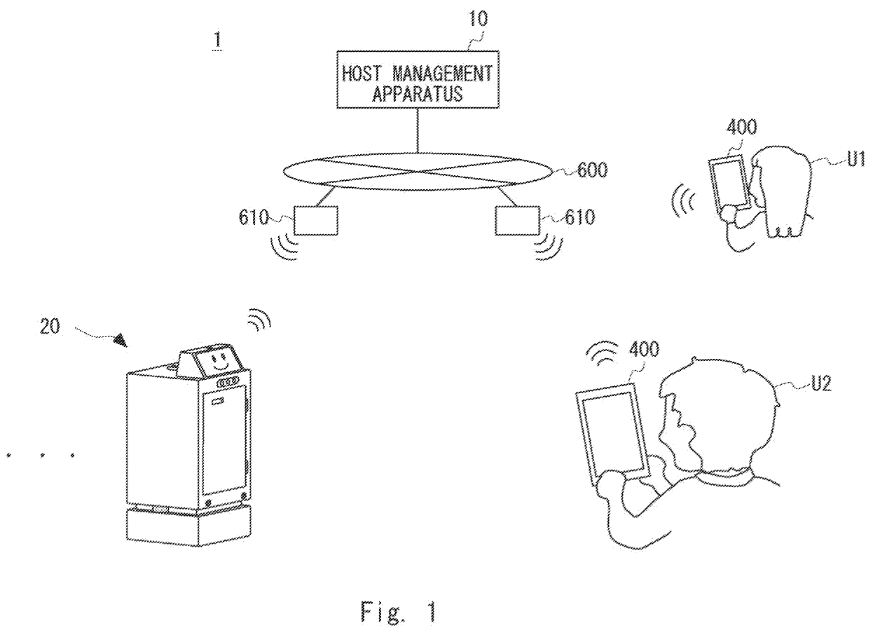

Firstly, an example of a conveyance system using a mobile robot into which the control system according to this embodiment can be incorporated will be described. FIG. 1 is a conceptual diagram for explaining an example of an overall configuration of a conveyance system 1 using a mobile robot 20 into which the control system according to this embodiment can be incorporated. For example, the mobile robot 20 is a conveyance robot that conveys, as its task, an object(s) to be conveyed. The mobile robot 20 autonomously travels in a medical and welfare facility, such as a hospital, a rehabilitation center, a nursing facility, and a facility in which aged persons live, in order to convey objects to be conveyed. Further, the conveyance system according to this embodiment can also be used in a commercial facility such as a shopping mall.

A user U1 stores (i.e., puts) an object to be conveyed in the mobile robot 20 and requests the conveyance thereof. The mobile robot 20 autonomously moves to a set destination so as to convey the object to be conveyed thereto. That is, the mobile robot 20 performs a task for conveying luggage (hereinafter also referred to simply as a task). In the following description, the place where the object to be conveyed are loaded is referred to as a conveyance origin, and the place to which the object is delivered is referred to as a conveyance destination.

For example, it is assumed that the mobile robot 20 moves in a general hospital having a plurality of clinical departments. The mobile robot 20 conveys supplies, consumable articles, medical instruments, and the like between a plurality of clinical departments. For example, the mobile robot 20 delivers an object to be conveyed from a nurse station of one clinical department to a nurse station of another clinical department. Alternatively, the mobile robot 20 delivers an object to be conveyed from a storage room for supplies and medical instruments to a nurse station of a clinical department. Further, the mobile robot 20 delivers medicines prepared in a pharmaceutical department to a clinical department where the medicines are used or a patient who use the medicines.

Examples of the objects to be conveyed include consumable articles such as medicines or bandages, specimens, testing instruments, medical instruments, hospital meals, and supplies such as stationery. Examples of medical instruments include a sphygmomanometer, a blood transfusion pump, a syringe pump, a foot pump, a nurse-call button, a bed sensor, a foot pump, a low-pressure continuous inhaler electrocardiogram monitor, a medicine infusion controller, an enteral nutrition pump, a respirator, a cuff pressure meter, a touch sensor, an aspirator, a nebulizer, a pulse oximeter, a sphygmomanometer, a resuscitator, an aseptic apparatus, and an echo apparatus. Further, the mobile robot 20 may convey meals such as hospital meals and test meals. Further, the mobile robot 20 may convey used apparatuses, used tableware, and the like. When the conveyance destination is located on a floor different from that on which the mobile robot 20 is located, the mobile robot 20 may move to the destination by using an elevator or the like.

The conveyance system 1 includes the mobile robot 20, a host management apparatus 10, a network 600, a communication unit 610, and a user terminal 400. The user U1 or U2 can request the conveyance of the object to be conveyed through the user terminal 400. For example, the user terminal 400 is a tablet-type computer or a smartphone. However, the user terminal 400 may be any information processing apparatus capable of performing communication wirelessly or thorough a cable.

In this embodiment, the mobile robot 20 and the user terminal 400 are connected to the host management apparatus 10 through the network 600. The mobile robot 20 and the user terminal 400 are connected to the network 600 through the communication unit 610. The network 600 is a wired or wireless LAN (Local Area Network) or a WAN (Wide Area Network). Further, the host management apparatus 10 is connected to the network 600 wirelessly or through a cable. The communication unit 610 is, for example, a wireless LAN unit installed in the environment of its own apparatus or the like. The communication unit 610 may be, for example, a general-purpose communication device such as a WiFi (Registered Trademark) router.

Various signals transmitted from the user terminal 400 of the user U1 or U2 are temporarily sent to the host management apparatus 10 through the network 600, and then transferred (i.e., forwarded) from the host management apparatus 10 to the target mobile robot 20. Similarly, various signals transmitted from the mobile robot 20 are temporarily sent to the host management apparatus 10 through the network 600, and then transferred (i.e., forwarded) from the host management apparatus 10 to the target user terminal 400. The host management apparatus 10 is a server connected to each of the apparatuses, and collects data from each of the apparatuses. Further, the host management apparatus 10 is not limited to a physically single apparatus, and may instead include a plurality of apparatuses over which processes are performed in a distributed manner. Further, the host management apparatus 10 may be formed in a distributed manner over a plurality of edge devices such as the mobile robot 20. For example, a part of or the whole conveyance system 1 may be disposed in the mobile robot 20.

The user terminal 400 and the mobile robot 20 may transmit and receive signals therebetween without any intervention by the host management apparatus 10. For example, the user terminal 400 and the mobile robot 20 may directly transmit and receive signals therebetween through radio communication. Alternatively, the user terminal 400 and the mobile robot 20 may transmit and receive signals therebetween through the communication unit 610.

The user U1 or U2 requests conveyance of an object to be conveyed by using the user terminal 400. In the following description, it is assumed that the user U1 is a person who is present at a conveyance origin and requests conveyance, and the user U2 is a person who is present at a conveyance destination (a destination) and is an intended recipient. Needless to say, it is also possible that the user U2, which is present at the conveyance destination, can request conveyance. Further, a user who is present at a place other than the conveyance origin and the conveyance destination may request conveyance.

When the user U1 requests conveyance, he/she inputs, by using the user terminal 400, the contents of the object to be conveyed, the place where the object to be conveyed (i.e., the object that needs to be conveyed from there) is received (hereinafter also referred to as the conveyance origin), the destination of the object to be conveyed (hereinafter also referred to as conveyance destination), the scheduled (or estimated) arrival time at the conveyance origin (the scheduled receiving time of the object to be conveyed), the scheduled (or estimated) arrival time at the conveyance destination (the deadline of the conveyance), and the like. Hereinafter, these information items are also referred to as conveyance request information. The user U1 can input conveyance request information by operating a touch panel of the user terminal 400. The conveyance origin may be the place where the user U1 is present or the place where the object to be conveyed is stored. The conveyance destination is the place where the user U2 or a patient who will use the object to be conveyed is present.

The user terminal 400 transmits the conveyance request information input by the user U1 to the host management apparatus 10. The host management apparatus 10 is a management system that manages a plurality of mobile robots 20. The host management apparatus 10 transmits an operation command for performing a conveyance task to the mobile robot 20. The host management apparatus 10 determines, for each conveyance request, a mobile robot 20 that will perform that conveyance task. Then, the host management apparatus 10 transmits a control signal including an operation command to that mobile robot 20. The mobile robot 20 moves according to the operation command so that it leaves the conveyance origin and arrives at the conveyance destination.

For example, the host management apparatus 10 assigns a conveyance task to a mobile robot 20 present at or near the conveyance origin. Alternatively, the host management apparatus 10 assigns the conveyance task to a mobile robot 20 which is moving toward the conveyance origin or the vicinity thereof. The mobile robot 20 to which the task is assigned moves to the conveyance origin to collect the object to be conveyed. The conveyance origin is, for example, the place where the user U1 who has requested the task is present.

When the mobile robot 20 arrives at the conveyance origin, the user U1 or other staff members load (i.e., put) the object to be conveyed into the mobile robot 20. The mobile robot 20 containing the object to be conveyed autonomously moves to its destination which is the conveyance destination. The host management apparatus 10 transmits a signal to the user terminal 400 of the user U2 at the conveyance destination. In this way, the user U2 can know that the object to be conveyed are being conveyed and know its scheduled arrival time. When the mobile robot 20 arrives at the set conveyance destination, the user U2 can receive the object to be conveyed stored in the mobile robot 20. In this manner, the mobile robot 20 performs the conveyance task.

In the overall configuration described above, the robot control system for the control of the mobile robot 20 in the conveyance system 1 can be constructed in a distributed manner in which the components are distributed over the mobile robot 20, the user terminal 400, and the host management apparatus 10. Alternatively, the robot control system can be constructed by collectively disposing all the components of the robot control system, i.e., all the substantial components for implementing the conveyance of an object to be conveyed by the mobile robot 20, in one apparatus. The host management apparatus 10, which can function as this apparatus, controls one or a plurality of mobile robots 20.

The mobile robot 20 used in the conveyance system 1 can be constructed as a mobile robot that autonomously moves by referring to a map. The robot control system, which controls the mobile robot 20, acquires, for example, distance information indicating a distance to a person measured by using a range sensor. The robot control system estimates a movement vector indicating a moving speed and a moving direction of a person according to the change in the distance to the person. The robot control system adds costs for restricting the movement of the mobile robot 20 on the map. The robot control system controls to the mobile robot so that the mobile robot moves according to the costs that are updated according to the result of the measurement by the range sensor. The robot control system may be installed in the mobile robot 20, and/or a part of or the whole the robot control system may be installed in the host management apparatus 10. However, in this embodiment, the method for controlling the mobile robot 20 in the robot control system is not limited to any particular methods.

Further, the control system according to this embodiment can be incorporated into the conveyance system 1 together with the robot control system described above, or incorporated into the conveyance system 1 as an independent system. The components of this control system, i.e., the components of the control system for monitoring a person, may be constructed in a distributed manner over the mobile robot 20, the user terminal 400, and the host management apparatus 10, or may be collectively constructed in one apparatus. In the following description, an example in which the host management apparatus 10, which is as an example of the above-described apparatus, includes components of the control system, i.e., in which the host management apparatus 10 performs system control and a group classification process, i.e., includes a system control unit and a group classification unit will be described.

The system control unit controls a system including a plurality of cameras installed in a facility (which are, as an example, environment cameras in the following description). The group classification unit recognizes a feature(s) of a person photographed (i.e., photographed in a still image or in a moving image) by an environment camera, and classifies the person into a predetermined first group or a predetermined second group based on the feature(s). In this embodiment, an example in which the first group is a non-staff group and the second group is a staff group will be described. However, the classification of people can be made according to any of various other attributes. Further, the mobile robot 20 can also be regarded as an object to be monitored, and in such a case, the mobile robot 20 may be classified as a staff member.

The group classification unit can classify a person or the like by performing matching between images (e.g., face images) of staff members, which are stored in advance, and the image of the person photographed by the environment camera. The method for recognizing (detecting or extracting) a feature(s) of a person for classification is not limited to any particular methods. Further, the group classification unit can also classify a person or the like by using, for example, a machine-trained learning model. The group classification unit may, for example, classify a person according to a feature of clothing of the person or according to whether or not the person is carrying (e.g., wearing) a predetermined article. In this way, it is possible to easily classify a person.

A non-staff member and a staff member will be described. Users of a facility include a staff member who works in the facility and a non-staff member, i.e., people other than the staff. Note that in the case where the facility is a hospital, non-staff include patients, inpatients, visitors, outpatients, attendants, and the like. Staff include doctors, nurses, pharmacists, clerks, occupational therapists, and various employees. Further, the staff may also include persons who deliver various articles to the hospital, maintenance workers, cleaners, and the like. Staff is not limited to the employer and employees directly employed by the hospital and may include employees related to the hospital.

It is desired that the control system reduces the power consumption in an environment where there is a mixture of staff of the hospital or the like and non-staff, both of which are objects (i.e., persons) to be monitored. Therefore, the host management apparatus 10 needs to monitor the facility while appropriately reducing the power consumption according to the situation of the facility.

Specifically, the system control unit of the host management apparatus 10 selects a first operation mode when there is a person who belongs to the non-staff, and selects a second operation mode different from the first operation mode when there is no person who belongs to the non-staff. In the following description, the first operation mode is referred to as a non-staff mode and the second operation mode is referred to as a staff mode. However, as described previously in the description of the classification of the first and second groups, the mode can be selected according to other attributes.

For example, the system control unit can switch the mode to the second operation mode when it is recognized that there is no person belonging to the non-staff when the first operation mode has been selected, and can switch the mode to the first operation mode when it is recognized that there is a person belonging to the non-staff when the second operation mode has been selected.

Then, when the system control unit selects the second operation mode, it performs a group classification process so as to reduce either one of the number of environment cameras to be operated among the plurality of environment cameras provided in the facility and the number of environment cameras used as an information source in the classification performed by the group classification unit among the aforementioned plurality of environment cameras as compared with the number of environment cameras that are used when the first operation mode is selected. In the former case, the control target in the system control unit for the group classification process can be the environment cameras (control for switching of the operations/non-operations of the environment cameras), and in the latter case, the control target can be the group classification unit or an image data acquisition unit or the like that acquires image data used for the classification.

Further, in the second operation mode, the environment cameras to be used can be predetermined environment cameras, or the image data to be used can be image data acquired from predetermined environment cameras, but it is not limited to this example. For example, it is changed according to the time of day, or it is determined according to the position where a non-staff member was observed the last time. Further, in the first operation mode, the environment cameras to be used can be predetermined environment cameras, or the image data to be used can be image data acquired from predetermined environment cameras, but it is not limited to this example. For example, it is changed according to the time of day.

As described above, the system control unit enables the host management apparatus 10 to switch the mode for monitoring according to whether the person to be monitored is a staff member, who does not need to be monitored as much as possible, or a non-staff member, who needs to be monitoring as much as possible. Therefore, in the control system according to this embodiment, measures for reducing the monitoring load are taken according to the presence/absence of a non-staff person, i.e., when controlling a system including a plurality of environment cameras installed for monitoring in a facility, it is possible to flexibly change the processing load according to the situation (according to the scene) and thereby to reduce the power consumption.

### (Control Block Diagram)

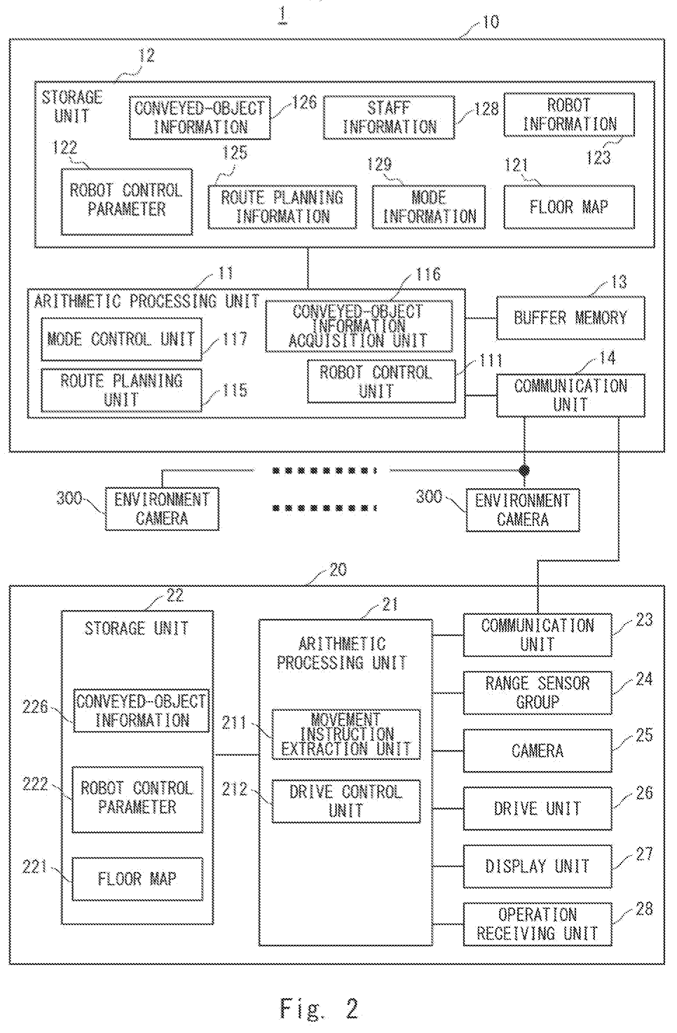

FIG. 2 is a control block diagram showing a control system of the conveyance system 1. As shown in FIG. 2, the conveyance system 1 includes a host management apparatus 10, a mobile robot(s) 20, and the above-described environment cameras 300.

The conveyance system 1 efficiently controls a plurality of mobile robots 20 while making the mobile robots 20 autonomously move in a certain facility. To do so, a plurality of environment cameras 300 are installed in the facility. For example, the environment cameras 300 are installed in a passage, a hall, an elevator, a doorway, and the like in the facility. The environment cameras 300 are used not only for controlling the mobile robots 20 but also for monitoring people as described above. However, in this embodiment, the environment cameras 300 may not be used for controlling the mobile robots 20. For example, the environment cameras 300 can be used only for monitoring people. Alternatively, cameras for monitoring people and cameras for monitoring the mobile robots 20 may be separately provided.

Each of the environment cameras 300 acquire an image of a range in which people and the mobile robots 20 move. Note that, in the conveyance system 1, the host management apparatus 10 collects images acquired by the environment cameras 300 and information based the images. In the case of images used for controlling the mobile robots 20, images and the like acquired by the environment cameras 300 may be directly transmitted to the mobile robots. Each of the environmental cameras 300 can be provided as a monitoring camera in a passage or a doorway in the facility. The environment cameras 300 may be used to determine the distribution of congestion states in the facility.

Regarding the conveyance, in the conveyance system 1, the host management apparatus 10 performs route planning based on conveyance request information. Based on the route planning information created by the host management apparatus 10, the host management apparatus 10 instructs each of the mobile robots 20 about its destination. Then, the mobile robot 20 autonomously moves toward the destination designated by the host management apparatus 10. The mobile robot 20 autonomously moves toward the destination by using sensors, a floor map, position information, and the like provided in the mobile robot 20 itself.

For example, the mobile robot 20 travels so as not to collide with any of apparatuses, objects, walls, or people in the area around the mobile robot 20 (hereinafter collectively referred to as nearby objects). Specifically, the mobile robot 20 detects a distance to a nearby object and travels while keeping at least a certain distance (also referred to as a threshold distance) from the nearby object. When the distance to the nearby object decreases to the threshold distance or shorter, the mobile robot 20 decelerates or stops. In this way, the mobile robot 20 can travel without colliding with the nearby object. Since the mobile robot 20 can avoid colliding with a nearby object, it can convey the object to be conveyed safely and efficiently.

The host management apparatus 10 includes an arithmetic processing unit 11, a storage unit 12, a buffer memory 13, and a communication unit 14. The arithmetic processing unit 11 performs calculation for monitoring people and the mobile robots 20, and calculation for controlling and managing the mobile robots 20. The arithmetic processing unit 11 can be implemented, for example, as an apparatus capable of executing a program, such as a central processing unit (CPU: Central Processing Unit) of a computer. Further, various functions can be implemented by the program. Although only a robot control unit 111, a route planning unit 115, a conveyed-object information acquisition unit 116, and a mode control unit 117, all of which are characteristic of the arithmetic processing unit 11, are shown in FIG. 2, other processing blocks may also be provided in the arithmetic processing unit 11.

The robot control unit 111 performs calculation for remotely controlling the mobile robot 20, and thereby generates a control signal. The robot control unit 111 generates the control signal based on route planning information 125 (which will be described later). Further, the robot control unit 111 generates the control signal based on various types of information obtained from the environment cameras 300 and the mobile robots 20. The control signal may include update information such as a floor map 121, robot information 123, and robot control parameters 122 (which will be described later). That is, when any of the various types of information is updated, the robot control unit 111 generates a control signal corresponding to the updated information.

The conveyed-object information acquisition unit 116 acquires information about the object to be conveyed. The conveyed-object information acquisition unit 116 acquires information about the contents (the type) of an object to be conveyed that a mobile robot 20 is conveying. The conveyed-object information acquisition unit 116 acquires conveyed-object information about the object to be conveyed that a mobile robot 20 in the error state is conveying.

The route planning unit 115 performs route planning for each of the mobile robots 20. When a conveyance task is input, the route planning unit 115 performs route planning for conveying the object to be conveyed to its conveyance destination (the destination) based on conveyance request information. Specifically, the route planning unit 115 determines a mobile robot 20 that will perform the new conveyance task by referring to the route planning information 125, the robot information 123, and the like which have already been stored in the storage unit 12. The start point is, for example, the current position of the mobile robot 20, the conveyance destination of the immediately preceding conveyance task, the place where the object to be conveyed (i.e., the object that needs to be conveyed from there) are received, or the like. The destination is the conveyance destination of the object to be conveyed, a waiting place, a charging place, or the like.

In this example, the route planning unit 115 sets passing points between the start point of the mobile robot 20 and the destination thereof. The route planning unit 115 sets, for each mobile robot 20, the passing order of passing points according to which the mobile robot 20 passes the passing points. For example, passing points are set at a branch point, an intersection, a lobby in front of an elevator, a vicinity thereof, and the like. Further, in a narrow passage, it may be difficult for two or more mobile robots 20 to pass each other. In such a case, a passing point may be set in front of the narrow passage. On the floor map 121, candidates for passing points may be registered in advance.

The route planning unit 115 determines (i.e., selects), for each conveyance task, a mobile robot 20 from among the plurality of mobile robots 20 so that tasks are efficiently performed in the whole system. The route planning unit 115 preferentially assigns a conveyance task to a mobile robot 20 on standby or a mobile robot 20 located close to its conveyance origin.

The route planning unit 115 sets passing points including the start point and the destination for the mobile robot 20 to which the conveyance task has been assigned. For example, when there are at least two travelling routes from the conveyance origin to the conveyance destination, the route planning unit 115 sets passing points so that the mobile robot 20 can move from the conveyance origin to the conveyance destination in a shorter time. Therefore, the host management apparatus 10 updates information indicating congestion states of passages based on images taken by cameras or the like. Specifically, the degree of congestion is high in places where other mobile robots 20 are passing or where there are many people. Therefore, the route planning unit 115 sets passing points so as to avoid places in which the degree of congestion is high.

In some cases, the mobile robot 20 can move to the destination in either a counterclockwise traveling route or a clockwise traveling route. In such cases, the route planning unit 115 sets passing points so that the mobile robot 20 travels through the traveling route which is less congested. When the route planning unit 115 sets one or a plurality of passing points between the start point and the destination, the mobile robot 20 can travel through a traveling route which is not crowded. For example, when the passage is divided at a branch point or an intersection, the route planning unit 115 sets passing points at the branch point, the intersection, a corner, and a vicinity thereof. In this way, the conveyance efficiency can be improved.

The route planning unit 115 may set passing points with consideration given to the congestion state of an elevator, a moving distance, and the like. Further, the host management apparatus 10 may estimate the number of mobile robots 20 and the number of people at a certain place at a scheduled time at which the mobile robot 20 will pass the certain place. Then, the route planning unit 115 may set passing points according to the estimated congestion state. Further, the route planning unit 115 may dynamically change passing points according to the change in the congestion state. The route planning unit 115 sequentially sets passing points for the mobile robot 20 to which the conveyance task is assigned. The passing points may include the conveyance origin and the conveyance destination. As will be described later, the mobile robot 20 autonomously moves so as to sequentially pass through the passing points set by the route planning unit 115.

The mode control unit 117 includes the above-described group classification unit, and corresponds to a part of or the whole system control unit. The mode control unit 117 performs control for switching the mode between the first operation mode (which is, as an example, a non-staff mode) and the second operation mode (which is, as an example, a staff mode) according to the situation of the facility. By switching the mode according to the situation of the facility, it is possible to reduce the processing load and reduce the power consumption. The control performed by the mode control unit 117 will be described later.

The storage unit 12 is a storage unit in which information necessary for the monitoring of people, and for the management and control of the robots including the monitoring of the robots is stored. Although a floor map 121, robot information 123, a robot control parameter(s) 122, route planning information 125, conveyed-object information 126, staff information 128, and mode information 129 are shown in the example shown in FIG. 2, other information may also be stored in the storage unit 12. When various types of processing are performed, the arithmetic processing unit 11 performs calculation by using information stored in the storage unit 12. Further, the various types of information stored in the storage unit 12 can be updated to the latest information.

The floor map 121 is map information of the facility where the mobile robots 20 move. This floor map 121 may be created in advance, or may be created from information obtained from the mobile robots 20. Alternatively, the floor map 121 may be one that is obtained by adding map correction information generated from information obtained from the mobile robots 20 to a base map created in advance.

For example, in the floor map 121, locations of wall surfaces, gates, doors, stairs, elevators, fixed shelves, and the like in the facility are recorded. The floor map 121 may be expressed as a 2D (two-dimensional) grid map. In such a case, information about a wall, a door, or the like is added in each grid on the floor map 121.

In the robot information 123, IDs, model numbers, specifications, and the like of the mobile robots 20 managed by the host management apparatus 10 are described (i.e., contained). The robot information 123 may include position information indicating the current positions of the mobile robots 20. The robot information 123 may include information as to whether the mobile robots 20 are performing tasks or are on standby. Further, the robot information 123 may include information indicating whether the mobile robots 20 are in operation or in faulty states. Further, the robot information 123 may include information about the object to be conveyed that can be conveyed and those that cannot be conveyed.

In the robot control parameters 122, control parameters such as a threshold distance between the mobile robot 20 managed by the host management apparatus 10 and a nearby object are described (i.e., contained). The threshold distance is a margin distance for avoiding collision with nearby objects including people. Further, the robot control parameters 122 may include information related to the operational strength such as a speed upper limit value for the moving speed of the mobile robot 20.

The robot control parameters 122 may be updated according to the situation. The robot control parameters 122 may include information indicating the availability (i.e., the vacancy) or the used state of the storage space of a storage box 291. The robot control parameters 122 may include information about the object to be conveyed that can be conveyed and those that cannot be conveyed. In the robot control parameters 122, the above-described various types of information are associated with each of the mobile robots 20.

The route planning information 125 includes route planning information planned by the route planning unit 115. The route planning information 125 includes, for example, information indicating a conveyance task. The route planning information 125 may include information such as an ID of the mobile robot 20 to which the task is assigned, the start point, the contents of the object to be conveyed, the conveyance destination, the conveyance origin, the scheduled arrival time at the conveyance destination, the scheduled arrival time at the conveyance origin, and the deadline of the arrival. In the route planning information 125, the above-described various types of information may be associated with each conveyance task. The route planning information 125 may include at least a part of conveyance request information input by the user U1.

Further, the route planning information 125 may include information about passing points for each mobile robot 20 or each conveyance task. For example, the route planning information 125 includes information indicating the passing order of passing points for each mobile robot 20. The route planning information 125 may include the coordinates of each passing point on the floor map 121 and information as to whether or not the mobile robot 20 has passed the passing point.

The conveyed-object information 126 is information about the object to be conveyed for which a conveyance request has been made. For example, the conveyed-object information 126 include information such as the contents (the type) of the object, the conveyance origin, and the conveyance destination. The conveyed-object information 126 may include the ID of the mobile robot 20 in charge of the conveyance. Further, the conveyed-object information may include information indicating a status such as “during conveyance”, “before conveyance” (“before loading”), and “conveyed”. In the conveyed-object information 126, the above-described information is associated with each conveyed object. The conveyed-object information 126 will be described later.

The staff information 128 is information for classifying whether a user of the facility is a staff member or not. That is, the staff information 128 includes information for classifying a person included (i.e., shown) in image data into a non-staff group or a staff group. For example, the staff information 128 includes information about staff members registered in advance. The mode information 129 includes information for controlling each mode based on the result of the classification. Note that details of the staff information 128 and the mode information 129 will be described later.

Note that the route planning unit 115 performs route planning by referring to various types of information stored in the storage unit 12. For example, a mobile robot 20 that will perform a task is determined based on the floor map 121, the robot information 123, the robot control parameters 122, and the route planning information 125. Then, the route planning unit 115 sets passing points up to the conveyance destination and the passing order thereof by referring to the floor map 121 and the like. On the floor map 121, candidates for passing points are registered in advance. Then, the route planning unit 115 sets passing points according to the congestion state and the like. Further, in the case where tasks are successively processed, the route planning unit 115 may set the conveyance origin and the conveyance destination as passing points.

Note that two or more mobile robots 20 may be assigned to one conveyance task. For example, when the volume of the object to be conveyed is larger than the maximum loading volume of the mobile robot 20, this object to be conveyed are divided into two loads (i.e., two portions) and loaded in two mobile robots 20, respectively. Alternatively, when the object to be conveyed are heavier than the maximum loading weight of the mobile robot 20, the object to be conveyed are divided into two loads and loaded in two mobile robots 20, respectively. By doing so, two or more mobile robots 20 can perform one conveyance task in a shared manner. Needless to say, when the host management apparatus 10 may control mobile robots 20 having different sizes, the route planning unit 115 may perform route planning so that a mobile robot 20 capable of conveying the object to be conveyed receives the object to be conveyed (i.e., takes the task of conveying the object to be conveyed).

Further, one mobile robot 20 may perform two or more conveyance tasks in parallel. For example, one mobile robot 20 is loaded with two or more objects to be conveyed at the same time, and this mobile robot 20 may successively convey them to different conveyance destinations. Alternatively, while one mobile robot 20 is conveying the object to be conveyed, this mobile robot 20 may load (i.e., collect) other objects to be conveyed. Further, the conveyance destinations of the object to be conveyed loaded at different locations may be the same as each other or different from each other. In this way, the tasks can be efficiently performed.

In such a case, storage information indicating the used state or the availability state of the storage space of the mobile robot 20 may be updated. That is, the host management apparatus 10 may control the mobile robot 20 by managing the storage information indicating the availability state. For example, when the loading or receiving of an object to be conveyed is completed, the storage information is updated. When a conveyance task is input, the host management apparatus 10 refers to the storage information, and thereby makes (i.e., instructs) a mobile robot 20 having an empty space in which the object to be conveyed can be loaded move to the conveyance origin to receive the object to be conveyed. In this way, one mobile robot 20 can perform a plurality of conveyance tasks at the same time, or two or more mobile robots 20 can perform a conveyance task in a shared manner. For example, a sensor may be installed in the storage space of the mobile robot 20, so that the availability state thereof is detected. Further, the volume and the weight of each of object to be conveyed may be registered in advance.

The buffer memory 13 is a memory which accumulates (i.e., stores) pieces of intermediate information generated during the processing performed by the arithmetic processing unit 11. The communication unit 14 is a communication interface for communicating with a plurality of environment cameras 300 provided in the facility where the conveyance system 1 is used, and communicating with at least one mobile robot 20. The communication unit 14 can perform both communication through a cable and wireless communication. For example, the communication unit 14 transmits, to each mobile robot 20, a control signal necessary for controlling that mobile robot 20. Further, the communication unit 14 receives information collected by the mobile robots 20 and the environment cameras 300. Further, the communication unit 14 transmits, to an environment camera(s) 300 to be controlled, information for remotely controlling the operation/non-operation of the environment camera(s) 300.

The mobile robot 20 includes an arithmetic processing unit 21, a storage unit 22, a communication unit 23, proximity sensors (e.g., a group of range sensors 24), a camera(s) 25, a drive unit 26, a display unit 27, and an operation receiving unit 28. Note that although only typical processing blocks provided in the mobile robot 20 are shown in FIG. 2, the mobile robot 20 may include a number of other processing blocks (not shown).

The communication unit 23 is a communication interface for communicating with the communication unit 14 of the host management apparatus 10. The communication unit 23 communicates with the communication unit 14, for example, by using a radio signal. The range sensor group 24 is, for example, composed of proximity sensors, and outputs proximity object distance information indicating a distance to an object or a person present in the area around the mobile robot 20. The range sensor group 24 includes a range sensor such as a lidar (LiDAR: Light Detection and Ranging, Laser Imaging Detection and Ranging), It is possible to measure a distance to a nearby object by manipulating the emitting direction of an optical signal. Further, a nearby object may be recognized from point group data detected (i.e., obtained) by a range sensor or the like. The camera 25 takes, for example, an image(s) that is used to recognize the situation around the mobile robot 20. Further, the camera 25 can also photograph, for example, position markers provided on the ceiling of the facility or the like. The mobile robot 20 may recognize its own position by using the position markers.

Further, the camera 25 can also be made to function as one of the environment cameras 300. In such a case, since the camera 25 is necessary to enable the moving mobile robot 20 to move, the objects, the number of which is to be reduced in the staff mode, do not include the camera 25 of the moving mobile robot 20 (the camera 25 is not disabled), but can include images from the camera 25 used as information source (i.e., the images from this camera 25 are not used).

The drive unit 26 drives a driving wheel(s) provided in the mobile robot 20. Note that the drive unit 26 may include an encoder(s) that detects the number of rotations of the driving wheel(s) or the driving motor(s) thereof. The position (the current position) of the mobile robot 20 itself may be estimated according to the output of the encoder. The mobile robot 20 detects its own current position and transmits it to the host management apparatus 10. The mobile robot 20 estimates its own position on the floor map 121 by using an odometry or the like.

The display unit 27 and the operation receiving unit 28 are implemented by a touch panel display. The display unit 27 displays a user interface screen (e.g_{.}, a user interface window) that serves as the operation receiving unit 28. Further, the display unit 27 can display information indicating the destination of the mobile robot 20 and/or the state of the mobile robot 20. The operation receiving unit 28 receives an operation from a user. The operation receiving unit 28 includes various switches provided in the mobile robot 20 in addition to the user interface screen displayed on the display unit 27.

The arithmetic processing unit 21 performs calculation for controlling the mobile robot 20. The arithmetic processing unit 21 can be implemented, for example, as an apparatus capable of executing a program, such as a central processing unit (CPU) of a computer. Further, various functions can be implemented by the program. The arithmetic processing unit 21 includes a movement instruction extraction unit 211 and a drive control unit 212. Note that although only typical processing blocks provided in the arithmetic processing unit 21 are shown in FIG. 2, the arithmetic processing unit 21 may include other processing blocks (not shown). The arithmetic processing unit 21 may search for a path between passing points.

The movement instruction extraction unit 211 extracts a movement instruction from the control signal provided from the host management apparatus 10. For example, the movement instruction includes information about the next passing point. For example, the control signal may include information about the coordinates of passing points and the passing order thereof. Further, the movement instruction extraction unit 211 extracts the above-described information as a movement instruction.

Further, the movement instruction may include information indicating that the mobile robot 20 can move to the next passing point. If a passage is narrow, two or more mobile robot 20 may not pass each other. Further, a passage may be temporarily blocked. In such a case, the control signal includes an instruction to stop the mobile robot 20 at a passing point in front of the place where the mobile robot 20 should stop. Then, after the other mobile robot 20 has passed or after it becomes possible to pass the passage, the host management apparatus 10 outputs, to the mobile robot 20, a control signal for informing the mobile robot 20 that it can move through the passage. As a result, the mobile robot 20, which has temporarily stopped, starts to move again.

The drive control unit 212 controls the drive unit 26 so that the mobile robot 20 moves based on the movement instruction provided from the movement instruction extraction unit 211. For example, the drive unit 26 include a driving wheel(s) that rotates according to a control command value provided from the drive control unit 212. The movement instruction extraction unit 211 extracts a movement instruction so that the mobile robot 20 moves toward a passing point received from the host management apparatus 10. Then, the drive unit 26 rotationally drives the driving wheel(s). The mobile robot 20 autonomously moves toward the next passing point. By doing so, the mobile robot 20 passes through passing points in order (i.e., one after another) and arrives at the conveyance destination. Further, the mobile robot 20 may estimate its own position and transmit a signal indicating that it has passed the passing point to the host management apparatus 10. In this way, the host management apparatus 10 can manage the current position and the conveyance status of each mobile robot 20.

In the storage unit 22, the floor map 221, robot control parameters 222, and conveyed-object information 226 are stored. The information shown in FIG. 2 is a part of the information stored in the storage unit 22, and includes information other than the floor map 221, the robot control parameters 222, and the conveyed-object information 226 shown in FIG. 2. The floor map 221 is map information of the facility in which the mobile robots 20 are made to move. This floor map 221 is, for example, a map that is obtained by downloading the floor map 121 stored in the host management apparatus 10. Note that the floor map 221 may be created in advance. Further, the floor map 221 may not be map information for the whole facility, but may be map information for a part of the area in which the mobile robot 20 is supposed to move.

The robot control parameters 222 are parameters for operating the mobile robot 20. The robot control parameters 222 include, for example, a threshold distance to a nearby object. Further, the robot control parameters 222 include an upper limit value of the speed of the mobile robot 20.

Similarly to the conveyed-object information 126, the conveyed-object information 226 includes information about the object to be conveyed. For example, the conveyed-object information 126 includes information such as the contents (the type) of the object, the conveyance origin, and the conveyance destination. Further, the conveyed-object information may include information indicating a status such as “during conveyance”, “before conveyance” (“before loading”), and “conveyed”. In the conveyed-object information 226, the above-described information is associated with each of object to be conveyed. The conveyed-object information 226 may include information about the object conveyed by the mobile robot 20. Therefore, the conveyed-object information 226 is a part of the conveyed-object information 126. That is, the conveyed-object information 226 may not include information about the object to be conveyed by other mobile robots 20.

The drive control unit 212 refers to the robot control parameters 222, and when the distance indicated by the distance information obtained from the range sensor group 24 decreases beyond the threshold distance, makes the mobile robot 20 stop or decelerate. The drive control unit 212 controls the drive unit 26 so that the mobile robot 20 travels at a speed equal to or lower than the upper limit value of the speed thereof. The drive control unit 212 limits the rotational speed of the driving wheel so that the mobile robot 20 does not move at a speed equal to or higher than the upper limit value of the speed thereof.

### (Configuration of Mobile Robot 20)

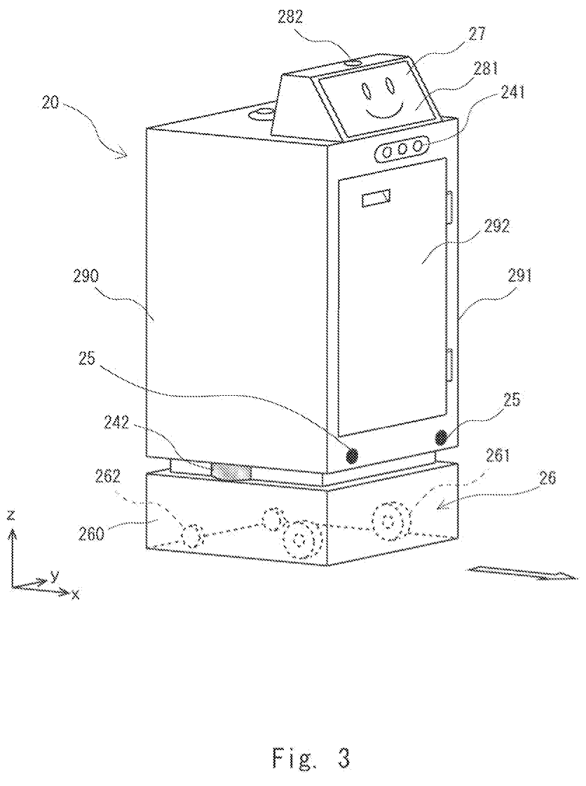

The external appearance of the mobile robot 20 will be described hereinafter. FIG. 3 shows a schematic diagram of the mobile robot 20. The mobile robot 20 shown in FIG. 3 is an example of the mobile robot 20, and the mobile robot 20 may have other shapes, appearances, and the like. Note that, in FIG. 3, the x-direction coincides with the forward/backward directions of the mobile robot 20, and the y-direction coincides with the left/right directions of the mobile robot 20. Further the z-direction is the height direction of the mobile robot 20.

The mobile robot 20 includes a body part 290 and a carriage part 260. The body part 290 is mounted on the carriage part 260. Each of the body part 290 and the carriage part 260 includes a rectangular parallelepiped housing, and various components are disposed in the housing. For example, the drive unit 26 is housed in the carriage age part 260.

The body part 290 includes a storage box 291 that serves as a storage space, and a door 292 for hermetically close the storage box 291. The storage box 291 includes multi-stage shelves, and the availability state (i.e., the vacancy state) of each stage is managed. For example, the mobile robot 20 can update the available state of each stage by disposing various sensors such as a weight sensor in each stage. The mobile robot 20 autonomously moves and thereby conveys the object to be conveyed stored in the storage box 291 to the destination indicated by the host management apparatus 10. A control box or the like (not shown) may be provided in the housing of the body part 290. Further, the door 292 may be configured so that it can be locked by an electronic key or the like. When the mobile robot 20 arrives at the conveyance destination, the user U2 unlocks the door 292 by the electronic key. Alternatively, when the mobile robot 20 arrives at the conveyance destination, the door 292 may be automatically unlocked.

As shown in FIG. 3, as the range sensor group 24, a front/rear range sensor 241 and a left/right range sensor 242 are provided on the exterior of the mobile robot 20. The mobile robot 20 measures a distance to a nearby object in the front/rear direction of the mobile robot 20 by the front/rear range sensor 241. Further, the mobile robot 20 measures a distance to the nearby object in the right/left direction of the mobile robot 20 by the left/right range sensor 242.

For example, a front/rear range sensor 241 is disposed on each of the front and rear surfaces of the housing of the body part 290. A left/right range sensor 242 is disposed on each of the left-side and right-side surfaces of the housing of the body part 290. Each of the front/rear range sensor 241 and the left/right range sensor 242 is, for example, an ultrasonic range sensor or a laser range finder. The distance to the nearby object is detected. When the distance to the nearby object detected by the front/rear range sensor 241 or the left/right range sensor 242 becomes equal to or shorter than the threshold distance, the mobile robot 20 decelerates or stops.

The drive unit 26 includes a driving wheel(s) 261 and a caster(s) 262. The driving wheel 261 is a wheel for moving the mobile robot 20 forward, backward, to the left, and to the right. The caster 262 is a driven wheel to which no driving force is supplied, and rolls so as to follow the driving wheel 261. The drive unit 26 includes a driving motor(s) (not shown) and drives the driving wheel(s) 261.

For example, the drive unit 26 supports, inside the housing, two driving wheels 261 and two casters 262 all of which are in contact with the surface on which the mobile robot travels. The two driving wheels 261 are arranged so that their rotational axes coincide with each other. Each of the driving wheels 261 is independently rotationally driven (i.e., independently rotated) by motors (not shown). The driving wheels 261 rotate according to control command values provided from the drive control unit 212 shown in FIG. 2. Each of the casters 262 is a trailing wheel, and is disposed in such a manner that its pivoting shaft, which vertically extends from the drive unit 26, rotatably supports the wheel at a point which is deviated from the rotating shaft of the wheel, and follows the driving wheel in the moving direction of the drive unit 26.

The mobile robot 20, for example, moves in a straight line when the two driving wheels 261 are rotated in the same direction at the same rotational speed, and turns around the vertical axis passing through substantially the center of the two driving wheels 261 when these wheels are rotated in the opposite direction at the same rotational speed. Further, the mobile robot 20 can move forward while turning left or right by rotating the two driving wheels 261 in the same direction at different rotational speeds. For example, the mobile robot 20 turns right by setting the rotational speed of the left driving wheel 261 higher than that of the right driving wheel 261. Conversely, the mobile robot 20 turns left by setting the rotational speed of the right driving wheel 261 higher than that of the left driving wheel 261. That is, the mobile robot 20 can move in a straight line, rotate on its own axis, or turn right or left in an arbitrary direction by individually controlling the rotational direction and the rotational speed of each of the two driving wheels 261.

Further, in the mobile robot 20, a display unit 27 and an operation interface 281 are provided on the upper surface of the body part 290. The operation interface 281 is displayed on the display unit 27. As a user touches the operation interface 281 displayed on the display unit 27, the operation receiving unit 28 can receive an instruction input from the user. Further, an emergency stop button 282 is provided on the upper surface of the display unit 27. The emergency stop button 282 and the operation interface 281 function as the operation receiving unit 28.

The display unit 27 is, for example, a liquid-crystal panel, and displays the face of a character (e.g., a mascot) in an illustration and/or presents (i.e., shows) information about the mobile robot 20 in text or using an icon. It is possible, by displaying the face of the character on the display unit 27, to give people in the area around the mobile robot 20 an impression that the display unit 27 is as if the face of the robot. The display unit 27 and the like provided in the mobile robot 20 can be used as the user terminal 400.

The camera 25 is disposed on the front surface of the body part 290. In this example, two cameras 25 function as stereo cameras. That is, the two cameras 25 having the same angle of view are horizontally arranged with an interval therebetween These cameras 25 take images and output them as image data It is possible to calculate the distance to the subject and the size thereof based on the image data of the two cameras 25. The arithmetic processing unit 21 can detect a person, an obstacle, or the like present ahead the mobile robot 20 in the moving direction by analyzing the images taken by the camera 25. When there is a person, an obstacle, or the like ahead the mobile robot 20 in the traveling direction, the mobile robot 20 moves along the route while avoiding it. Further, the image data of the camera 25 is transmitted to the host management apparatus 10.

The mobile robot 20 recognizes a nearby object and/or determines its own position by analyzing image data output from the camera 25 and detection signals output from the front/rear range sensor 241 and the left/right range sensor 242. The camera 25 photographs a scene (i.e., an area including objects, people, and the like) ahead of the mobile robot 20 in the traveling direction. As shown in the drawing, the side of the mobile robot 20 on which the camera 25 is disposed is defined as the front of the mobile robot 20. That is, when the mobile robot 20 is moving under normal circumstances, the forward direction of the mobile robot 20 is the traveling direction as indicated by an arrow.

### (Mode Control Process)

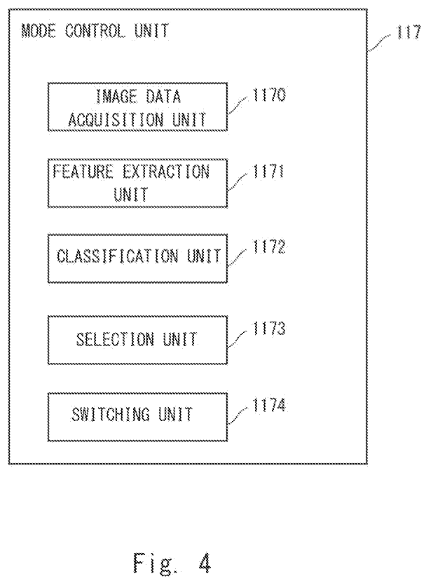

Next, a mode control process will be described with reference to FIG. 4. In the following description, it is assumed that the host management apparatus 10 performs a process for mode control. Therefore, FIG. 4 is a block diagram mainly showing a control system of the mode control unit 117. Needless to say, the mobile robot 20 may include a mode control unit and performs at least a part of the process performed by the mode control unit 117. Alternatively, the environment cameras 300 may perform at least a part of the process for mode control.

The mode control unit 117 includes an image data acquisition unit 1170, a feature extraction unit 1171, a classification unit 1172, a selection unit 1173, and a switching unit 1174. Although it is not shown in the drawings, the environment camera 300 includes an image pickup device and an arithmetic processing unit. The image pickup device takes an image (i.e., a still image or a moving image) in order to monitor the inside of the facility. The arithmetic processing unit of the environment cameras 300 includes a GPU (Graphical Processing Unit) that performs image processing and the like on an image taken by the image pickup device, and is configured so as to be able to respond to the control of the operation/non-operation received from the outside, and to stop/start the power supply (or to enter a low power mode).

The image data acquisition unit 1170 acquires image data of an image taken by the environment camera 300. Note that the image data may be the imaging data itself taken by the environment camera 300, or may be data obtained by processing the imaging data. For example, the image data may be data of a feature value(s) extracted from the imaging data. Further, information such as a shooting time and a shooting place may be added in the image data. Further, the image data acquisition unit 1170 may acquire not only image data from the environment camera 300 but also image data from the camera 25 of the mobile robot 20. That is, the image data acquisition unit 1170 may acquire image data based on an image taken by the camera 25 provided in the mobile robot 20. The image data acquisition unit 1170 may acquire image data from a plurality of environment cameras 300.

The feature extraction unit 1171 corresponds to a part of the above-described group classification unit, and extracts a feature(s) of a person shown in the taken image. More specifically, the feature extraction unit 1171 detect a person(s) included (shown) in the image data by performing image processing on image data. Then, the feature extraction unit 1171 extracts a feature(s) of the person included in the image data are extracted. Further, an arithmetic processing unit 311 provided in the environment camera 300 may perform at least a part of the process for extracting a feature value(s). Note that as means for detecting that a person is included in image data, various technologies such as machine learning including HOG (Histograms of Oriented Gradients) feature values and convolution processing are known to those skilled in the art. Therefore, details of the detection means will be omitted here.

The feature extraction unit 1171 detects the color of clothing of the detected person. More specifically, for example, the feature extraction unit 1171 calculates, from the clothing of the detected person, a ratio of an area having a specific color. Alternatively, the feature extraction unit 1171 detects, from the clothing of the detected person, the color of a specific part of the clothing. In this way, a feature detection unit 511 extracts a part characteristic to the clothing of a staff member.

Further, a shape characteristic to the clothing of a staff member or to an article (such as wearing article) carried by a staff member may be extracted as a feature. Further, a feature(s) in a face image obtained by the feature extraction unit 1171 may be extracted. That is, the feature extraction unit 1171 may extract a feature(s) for face recognition. The feature extraction unit 1171 supplies the extracted feature information to the classification unit 1172.

The classification unit 1172 corresponds to a part of the above-described group classification unit, and classifies a person into a predetermined first group or a predetermined second group based on the result of the feature extraction. For example, the classification unit 1172 classifies the person based on the feature information received from the feature extraction unit 1171 and the staff information 128 stored in the storage unit 12. The classification unit 1172 supplies the result of the classification to the selection unit 1173. The classification unit 1172 classifies a staff member into the second group and classifies a non-staff person into the first group. The classification unit 1172 supplies the classification result to the selection unit 1173.

Based on the classification result, the selection unit 1173 selects the non-staff mode when there is a person belonging to the non-staff group, and selects the staff mode when there is no person belonging to the non-staff group. Then, the selection unit 1173 provides the selection result to the switching unit 1174.

The switching unit 1174 switches the mode between the staff mode and the non-staff mode based on the result of the selection made in the selection unit 1173. For example, the switching unit 1174 can switch the mode to the staff mode when it is recognized that there is no person belonging to the non-staff group when the non-staff mode has been selected, and can switch the mode to the non-staff mode when it is recognized that there is a person belonging to the non-staff group when the staff mode has been selected.

When the mode control unit 117 selects the staff mode, it performs a group classification process so as to reduce either one of the number of environment cameras to be operated among the plurality of environment cameras 300 provided in the facility and the number of environment cameras used as an information source in the classification performed by the classification unit 1172 among the aforementioned plurality of environment cameras as compared with the number of environment cameras that are used when the non-staff mode is selected. In the former case, the control target of the switching unit 1174 for the group classification process can be the environment cameras 300 (control for switching of the operations/non-operations of the environment cameras 300), and in the latter case, the control target can be the image data acquisition unit 1170, or can be the feature extraction unit 1171 or the classification unit 1172.

When the switching unit 1174 control the operation/non-operation of the environment camera 300, it controls the power supply for the environment camera 300 to be controlled. Note that when the camera 25 of a certain mobile robot 20 is made to function as the environment camera 300, it is also possible to instruct the mobile robot 20 to stop the camera 25. When the switching unit 1174 controls the use/non-use of the environment camera 300 as an information source, it controls the image data acquisition unit 1170 so as to acquire image data of the environment camera 300 necessary as an information source, controls the feature extraction unit 1171 so as to extract a feature(s) only from this image data, or controls the classification unit 1172 so as to classify a person or the like based solely on this feature(s).

The switching unit 1174 may operate the aforementioned plurality of environment cameras 300 when the non-staff mode is selected, and may control the aforementioned plurality of environment cameras 300 so as to stop the operations of cameras other than a first camera(s) among the aforementioned plurality of environment cameras 300 when the staff mode is selected. The method for controlling the operation/non-operation (stop) of the environment camera 300 is not limited to any particular methods. That is, an existing remote power supply control technology may be used. In this way, in the case of the staff mode, it is possible to reduce the processing load in a state in which at least the first camera(s) necessary for monitoring is in operation.

Alternatively, the switching unit 1174 can control the aforementioned plurality of environment cameras 300 and the like so that when the non-staff mode is selected, the aforementioned plurality of environment cameras 300 are operated and the plurality of environment cameras 300 are used as an information source, and when the staff mode is selected, the first camera(s) among the aforementioned plurality of environment cameras 300 is operated and the first camera is used as an information source.

The aforementioned first camera(s) may include a camera provided at a position for monitoring a security gate in the facility. The security gate can be the doorway itself or an apparatus installed at the doorway. Alternatively, the security gate can be a key point (a monitoring point) itself in the facility or an apparatus installed at the key point. In this way, in the case of the staff mode, it is possible to reduce the processing load in a state in which at least the first camera(s) installed in the section where monitoring is necessary for security is in operation. Further, the aforementioned first camera may be the predetermined host camera among the aforementioned plurality of environment cameras 300, and the other cameras may be slave cameras.

Further, as shown in the conveyance system 1, which is shown as an example, the system control unit (the arithmetic processing unit 11 in the example shown in FIG. 2) of the host management apparatus 10 controls the mobile robot 20, which autonomously moves in a predetermined area in the facility, and the environment camera 300 can be disposed at a position away from the surface on which the mobile robot 20 travels so as to photograph the periphery of the traveling mobile robot 20. In this way, it is also possible to monitor the mobile robot 20 by using the environment camera 300 which is originally provided for monitoring people.

Further, the system control unit (the arithmetic processing unit 11 in the example shown in FIG. 2) of the host management apparatus 10 may control the aforementioned plurality of environment cameras 300 so as to change (add or switch) the camera that functions as the aforementioned first camera according to the traveling position of the mobile robot 20. In this way, it is also possible to monitor the mobile robot, and to reduce, in the case of the staff mode, the processing load in a state in which at least the first camera installed near the mobile robot 20 is in operation.

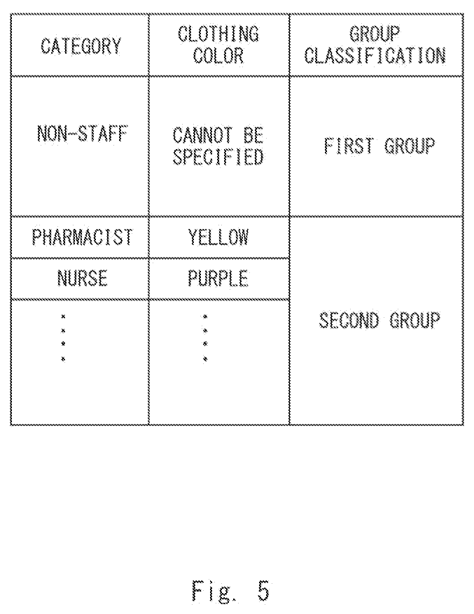

Next, an example of the staff information 128 is shown in FIG. 5. FIG. 5 is a table showing an example of the staff information 128. The staff information 128 is information for classifying staff members and non-staff members into corresponding groups according to their types. In the left column, the “Category” of staff members is shown. The items in the category of staff members include, from the top, “Non-staff,” “Pharmacist”, and “Nurse”. Needless to say, items other than those shown as examples may be included. On the right side of the category of staff members, columns “Clothing Color” and “Group Classification” are shown.

For each of the items in the category of staff members, the color (color tone) of clothing corresponding to the item will be described hereinafter. The color of clothing corresponding to “Non-staff” is “Cannot be specified”. That is, when the feature extraction unit 1171 detects a person from image data and when the color of the clothing of the detected person is not included in the predetermined colors, the feature extraction unit 1171 determines the detected person as “Non-staff”. Further, according to the staff information 128, the group classification corresponding to the “Non-staff” is the first group.

Colors of clothing are associated with the categories (i.e., the items in the categories). For example, it is assumed that a color of the uniform of a staff member is determined in advance for each of the categories. In this case, the color of the uniform is different from one category to another. Therefore, the classification unit 1172 can specify the category from the color of the clothing. Needless to say, staff members in one category may wear uniforms having different colors. For example, a nurse may wear a white uniform (a white coat) or a pink uniform. Alternatively, staff members in a plurality of categories may wear uniforms having the same color. For example, both nurses and pharmacists may wear white uniforms. Further, the feature is not limited to the color of clothing. That is, the shape of clothing, a cap, and the like may be used as the feature. Further, the classification unit 1172 specifies the category that corresponds to the feature of the person shown in the image. Needless to say, when two or more persons are included (shown) in the image, the classification unit 1172 specifies the category of each of the persons.

Since the classification unit 1172 determines whether the person is a staff member or not based on the color of his/her clothing, it is possible to easily and appropriately determine whether the person is a staff member or not. For example, even when a new staff member is added (i.e., joins), it is possible to determine whether this staff member is a staff member or not without using information about this staff member. Alternatively, the classification unit 1172 may classify whether the person is a non-staff person or a staff member according to the presence/absence of a predetermined article such as a name tag, an ID card, an admission card, or the like. For example, the classification unit 1172 classifies a person with a name tag attached to a predetermined part of his/her clothing as a staff member. Alternatively, the classification unit 1172 classifies a person with an ID card or an admission card put in a cardholder or the like hanging from his/her neck as a staff member.

Further, the classification unit 1172 may classify a person based on a feature(s) in a face image. For example, the staff information 128 may contain face images of staff members or feature values thereof in advance. Then, when a feature of the face of the person included (shown) in the image taken by the environment camera 300 can be extracted, it is possible to determine whether the person is a staff member or not by comparing this feature with the feature values of face images contained in the staff information 128. Further, in the case where the categories of staff members are registered in advance, it is possible to specify a staff member from the feature values of the face images. Needless to say, the classification unit 1172 can combine a plurality of features and classify a person based on the combined features.

As described above, the classification unit 1172 determines whether the person shown in the image is a staff member or not. The classification unit 1172 classifies a person who is a staff member into the second group. The classification unit 1172 classifies a person who is a non-staff person into the first group. That is, the classification unit 1172 classifies a person other than the staff members into the first group. In other words, the classification unit 1172 classifies a person who cannot be specified as a staff member into the first group. Note that it is preferred that the staff members are registered in advance, but a new staff member may be classified based on the color of his/her clothing.

The classification unit 1172 may be a machine-trained model generated through machine learning. In such a case, machine learning can be performed by using images taken for each category of staff members as teacher data. That is, it is possible to construct a machine-trained model having high classification accuracy by performing supervised learning using, as teacher data, image data to which categories of staff members are attached as correct labels. That is, photograph images (i.e., captured images, taken images, or acquired images) of staff members in a state in which they wear predetermined uniforms can be used as learning data.

The machine-trained model may be a model by which features are extracted by the feature extraction unit 1171 and the classification process is performed by the classification unit 1172. In this case, an image in which a person is shown is input into the machine-trained model, so that the machine-trained model outputs a classification result. Further, machine-trained models corresponding to features based on which a person or the like is classified may be used. For example, a machine-trained model for classifying a person based on the color of his/her clothing and a machine-trained model for classifying a person based on the feature value of a face image may be used independently of each other. Then, when the person is recognized as a staff member by any one of the machine-trained models, the classification unit 1172 determines that the person belongs to the second group. When the person cannot be specified as a staff member, the classification unit 1172 determines that the person belongs to the first group.

### (Mode Information)

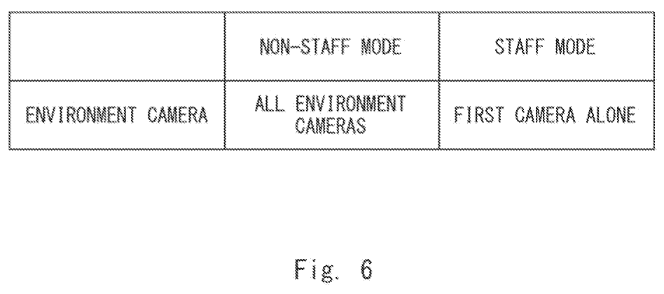

FIG. 6 is a table showing an example of the mode information 129. FIG. 6 shows a difference between processing in the non-staff mode and that in the staff mode. In FIG. 6, items in regard to the environment cameras are shown as items in regard to the objects (or the targets) of the mode control. The switching unit 1174 can switch between the items shown in FIG. 6 according to the mode indicated by the result of the selection made by the selection unit 1173.

As shown by the items for the environment cameras, the switching unit 1174 can use all the environment cameras 300 (or use them as an information source) in the non-staff mode, and can use only the first camera(s) (or use it as an information source) in the staff mode. The switching unit 1174 can turn on/off the power supply for the environment camera 300, or can bring the environment camera 300 into a sleep/non-sleep state In the staff mode, the environment camera 300 is turned off or brought into a sleep state. In the non-staff mode, the environment camera 300 operates without entering into a sleep state. That is, the switching unit 1174 outputs a control signal for turning on/off the power supply for the environment camera 300, or for bringing the environment camera 300 into a sleep/non-sleep state according to the mode. In the staff mode, since the environment camera 300 is turned off or brought into a sleep state, the processing load can be reduced and the power consumption can be reduced.

Further, items in regard to the number of camera pixels can be added in the mode information 129, so that the switching unit 1174 can also switch (i.e., change) the number of pixels of the environment camera 300. In the staff mode, the environment camera 300 outputs a photograph image (i.e., captured image, taken image, or acquired image) having a small number of pixels. Alternatively, one of the image data acquisition unit 1170, the feature extraction unit 1171, and the classification unit 1172 performs a thinning process so that the number of pixels of the photograph image used as an information source is reduced. In the non-staff mode, the environment camera 300 outputs a photograph image having a large number of pixels. Alternatively, the image data acquisition unit 1170, the feature extraction unit 1171, and the classification unit 1172 perform processing using the photograph image, which is used as an information source, as it is (i.e., without performing any additional process on the photograph image).

Further, in addition to or instead of the items for the number of camera pixels, items in regard to the frame rate may be provided, so that the switching unit 1174 can switch (i.e., change) the frame rate of the environment camera 300 according to the mode. In the staff mode, the environment camera 300 takes an image at a low frame rate. In the non-staff mode, the environment camera 300 takes an image at a high frame rate. That is, the switching unit 1174 outputs a control signal for switching (i.e., changing) the frame rate of the photograph image of the environment camera 300 according to the mode. Since the photograph image is taken at a high frame rate, the processing load of the processor or the like increases as compared with the processing load when the frame rate is low. Further, it is also possible to reduce the processing load and thereby reduce the power consumption by adding items other than those for the number of camera pixels and the frame rate as appropriate.

### (Example of Control Method)

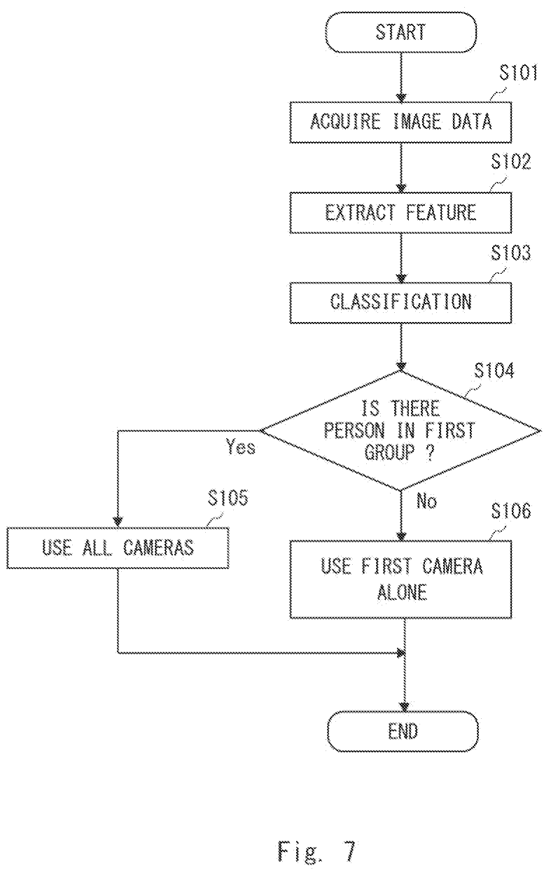

FIG. 7 is a flowchart showing an example of a control method according to this embodiment. Firstly, the image data acquisition unit 1170 acquires image data from the environment camera 300 (S101). That is, when the environment camera 300 takes an image of a monitoring area, it transmits the taken image to the host management apparatus 10. The image data may be a moving image or a still image. Further, the image data may be data obtained by performing various processes on the photograph image (i.e., the taken image).

Next, the feature extraction unit 1171 extracts a feature(s) of a person shown in the photograph image (S102). In this example, the feature extraction unit 1171 detects persons included (shown) in the photograph image and extracts a feature(s) of each person. For example, the feature extraction unit 1171 extracts the color of clothing of the person as a feature. Needless to say, the feature extraction unit 1171 may extract not only the color of clothing but also a feature value(s) for face recognition and/or the shape of clothing. The feature extraction unit 1171 may extract the presence/absence of a cap of a nurse, the presence/absence of a name tag, the presence/absence of an ID card, or the like as a feature.

The classification unit 1172 classifies the person included in the photograph image into the first group or the second group based on the feature(s) of the person (S103). The classification unit 1172 refers to staff information and thereby determines, for each person, whether or not the person belongs to the second group (staff) based on the feature(s) of the person. Specifically, the classification unit 1172 determines that the person belongs to the second group when the color of his/her clothing is the same as the predetermined color of the uniform. In this way, all the persons included (shown) in the photograph image are classified into the first group or the second group. Needless to say, the feature is not limited to the color of the clothing, and the classification unit 1172 can classify a person or the like using other features.

Then, the classification unit 1172 determines whether or not there is a person who belongs to the first group in the monitoring area (S104). When there is a person belonging to the first group (i.e., a non-staff person) (Yes in S104), the selection unit 1173 selects the high-load non-staff mode, and the switching unit 1174 performs control so as to use all the environment cameras 300 (or a larger number of environment cameras 300 than that in the staff mode) according to the selection result (S105).

When there is no person belonging to the first group (No in S104), the selection unit 1173 selects the low-load staff mode, and the switching unit 1174 performs control so as to use only the first camera(s) according to the selection result (S106).

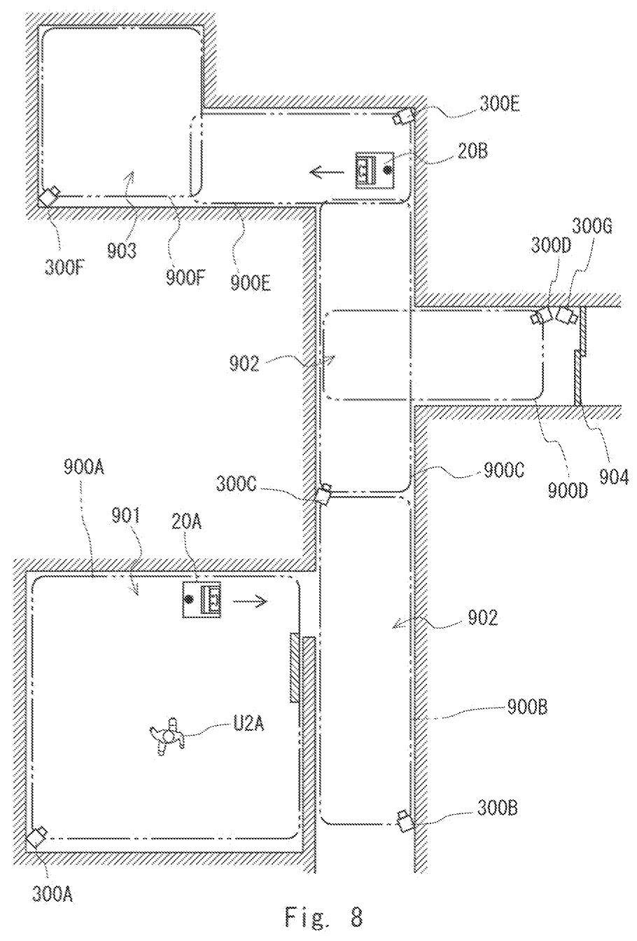

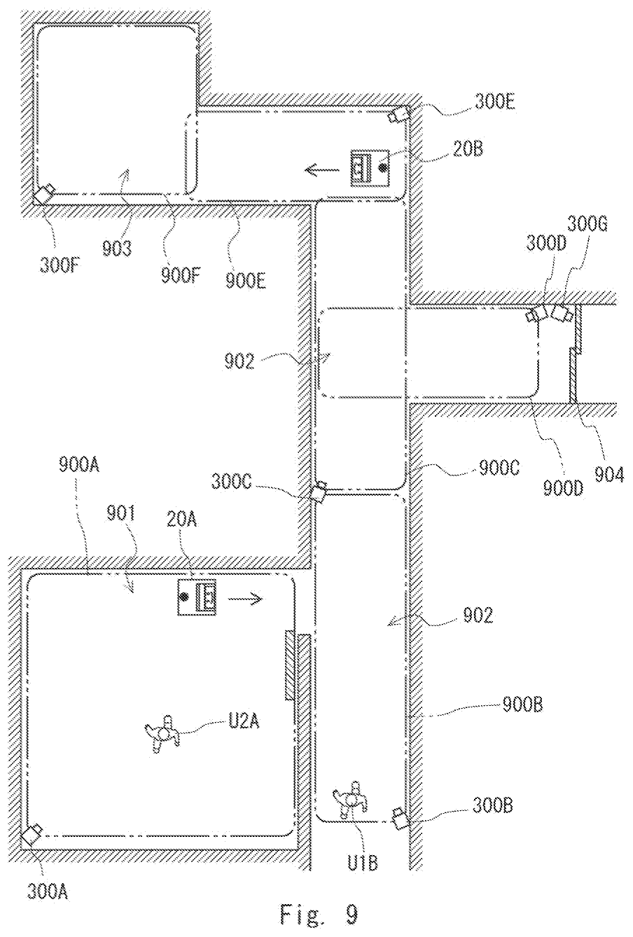

FIGS. 8 and 9 are diagrams for explaining specific examples of mode switching. FIGS. 8 and 9 are schematic views of a floor on which mobile robots 20 move as viewed from above. The facility includes a room 901, a room 903, and a passage 902. The passage 902 connects the room 901 with the room 903. In FIG. 8, six environment cameras 300 are identified as environment cameras 300A to 300G, respectively. The environment cameras 300A to 300G are installed at different positions and in different directions. The environment cameras 300A to 300G take images of different areas and, among them, the environment camera 300G is disposed at a position where it can check people who enter the facility or exit therefrom through a doorway 904 which functions as a security gate. The positions, the shooting directions, the shooting ranges, and the like of the environment cameras 300A to 300F may be registered in advance in a floor map 121.

The areas assigned to the environment cameras 300A to 300F are referred to as monitoring areas 900A to 900F, respectively. For example, the environment camera 300A photographs (i.e., takes a still image of a moving image of) the monitoring area 900A, and the environment camera 300B photographs the monitoring area 900B. Similarly, the environment cameras 300C, 300D, 300E and 300F photographs the monitoring areas 900C, 900D, 900E and 900F, respectively. The environment camera 300G photographs a range of (i.e., an area around) the doorway 904. As described above, the plurality of environment cameras 300A to 300G are installed in the facility to be monitored. Further, the facility is divided into the plurality of monitoring areas. The information about the monitoring areas may be registered in advance in the floor map 121.

As shown in FIG. 8, when there is only a staff member U2A in the facility, the selection unit 1173 selects the low-load staff mode, and the switching unit 1174 performs control so as to use only the first camera(s) according to this selection result. Note that the first camera can be, for example, the monitoring camera 300G alone that monitors the doorway 904.

On the other hand, as shown in FIG. 9, when there is a non-staff person U1B in the facility (irrespective of the presence of a staff member), the selection unit 1173 selects the high-load non-staff mode, and the switching unit 1174 performs control so as to use all the environment cameras 300A to 300G (or a larger number of environment cameras 300 than that in the staff mode) according to this selection result.

Although the above description has been given on the assumption that each of the environment cameras 300A to 300G monitors one monitoring area for simplifying the description, one environment camera 300 may monitor a plurality of monitoring areas. Alternatively, a plurality of environment cameras 300 may monitor one monitoring area (i.e., the same monitoring area). That is, the shooting ranges of two or more environment cameras may overlap each other. In such a case, control may be performed so that the use of some of the environment cameras whose shooting ranges overlap each other or the use of them as an information source is stopped in the staff mode, and all of the environment cameras whose shooting ranges overlap each other are used or are used as an information source in the non-staff mode

Further, although the above description has been given on the assumption that the host management apparatus 10 detects the entering and the leaving of a person or the like based on a photograph image, other types of information may be used for the detection. For example, in the case where an automatic door or a security door is provided, the entering and the leaving of a person may be detected according to the operation of the door.

### (Other Example of Control Method)

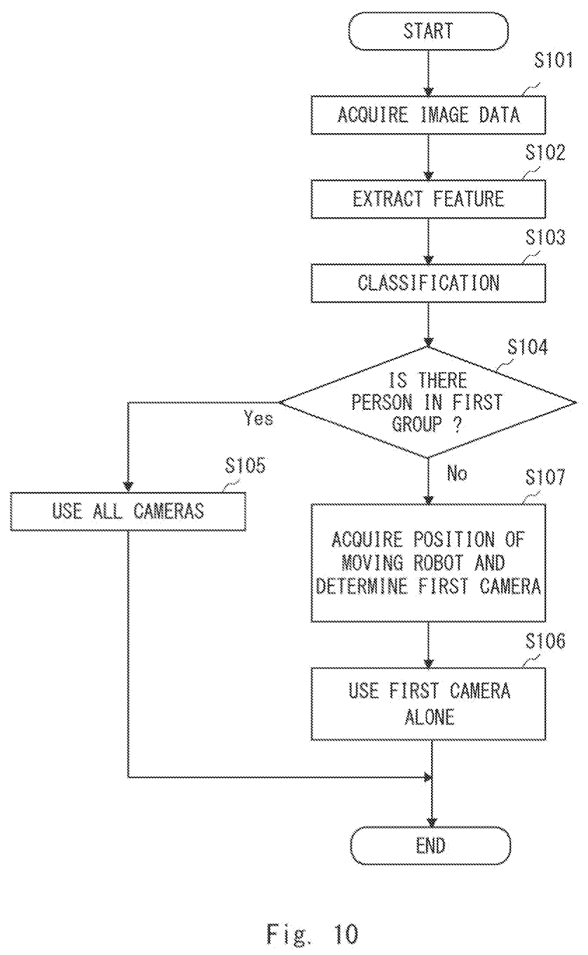

FIG. 10 is a flowchart showing another example of the control method according to this embodiment. Regarding processes similar to those shown in FIG. 7, only outlines of them will be described without describing details thereof. Firstly, the image data acquisition unit 1170 acquires image data from the environment camera 300 (S101). Next, the feature extraction unit 1171 extracts a feature(s) of a person shown in the photograph image (S102). Next, the classification unit 1172 classifies the person included (shown) in the photograph image into the first group or the second group based on the feature(s) of the person (S103). The classification unit 1172 refers to staff information and thereby determines, for each person, whether or not the person belongs to the second group (staff) based on the feature(s) of the person.

Then, the classification unit 1172 determines whether or not there is a person who belongs to the first group in the monitoring area (S104). When there is a person belonging to the first group (i.e., a non-staff person) (Yes in S104), the selection unit 1173 selects the high-load non-staff mode, and the switching unit 1174 performs control so as to use all the environment cameras 300 (or a larger number of environment cameras 300 than that in the staff mode) according to the selection result (S105).

When there is no person belonging to the first group (No in S104), the selection unit 1173 selects the low-load staff mode, and the switching unit 1174 acquires the traveling position of the mobile robot 20 according to the selection result, and determines the first camera(s) according to the acquired traveling position (S107). For example, it is possible to regard the traveling position as a position where the monitoring does not need to be carefully performed, and hence to determine an environment camera 300 disposed at a position away from the traveling position of the mobile robot 20 as the first camera, or to determine an environment camera 300 at a position away from the traveling position and the traveling route as the first camera. Then, control is performed so that only the first camera(s) determined by the switching unit 1174 is used (S106).

As shown in FIG. 8, when there is only a staff member U2A in the facility, the selection unit 1173 selects the low-load staff mode, and the switching unit 1174 acquires the positions of the mobile robots 20A and 20B according to the selection result, and determines the first camera(s). In this example, it is possible to stop the monitoring of the monitoring areas 900A and 900B and the monitoring areas 900E and 900F according to the positions and the moving directions of the mobile robots 20A and 20B, respectively, and determine the environment cameras 300C, 300D and 300G as the first cameras. Then, the switching unit 1174 performs control so as to use only these first cameras.

On the other hand, as shown in FIG. 9, when there is a non-staff person U1B in the facility (irrespective of the presence of a staff member), the selection unit 1173 selects the high-load non-staff mode, and the switching unit 1174 performs control so as to use all the environment cameras 300A to 300G (or a larger number of environment cameras 300 than that in the staff mode) according to this selection result. An example in which the number of environment cameras 300 is larger than the number of environment cameras 300 in the staff mode will be described. For example, in the non-staff mode, the switching unit 1174 performs control so as to stop the monitoring of the monitoring areas 900A and 900E according to the positions of the mobile robots 20A and 20B, and use the environment cameras 300B, 300C, 300D, 300F and 300G for the other monitoring areas.

The embodiment has been described above. The control method according to this embodiment may be performed by the host management apparatus 10 or may be performed by an edge device(s). The edge device includes, for example, at least one of an environment camera 300, a mobile robot 20, a communication unit 610, and a user terminal 400. Further, the environment camera 300, the mobile robot 20, and the host management apparatus 10 may perform the control method in a cooperated manner. That is, the control system according to this embodiment may be installed in the environment camera 300 and the mobile robot 20. Alternatively, at least a part of or the whole control system may be installed in an apparatus other than the mobile robot 20, e.g., in the host management apparatus 10. The host management apparatus 10 is not limited to a physically single apparatus, but may be distributed over a plurality of apparatuses. That is, the host management apparatus 10 may include a plurality of memories and a plurality of processors.

### (Alternative Example)

The conveyance system 1, the host management apparatus 10, the mobile robot 20, the user terminal 400, the environment camera 300, and the communication unit 610 according to the above-described embodiment are not limited to those that have certain shapes as shown above and perform certain control as described above. That is, they may have any shapes and perform any control as long as they can implement their functions.

Further, in the above-described embodiment, a person or the like is classified into the first group or the second group, and the mode is switched between the first operation mode and the second operation mode. However, a person or the like may be classified into one of three or more groups, and the mode may be switched among three or more modes according to whether or not there is a person or the like is included in one or two or more of the groups. In such a case, the operation modes can be modes in which the number of monitoring cameras to be used or the number of monitoring cameras to be used as an information source of image data is reduced in a stepwise manner according to the unimportance of monitoring.

Further, although the above-described embodiment has been described by using an example in which the control system is incorporated into a conveyance system, the control system may not be incorporated into a conveyance system, or may be constructed as a control system for monitoring people irrespective of whether mobile robots are used or not.

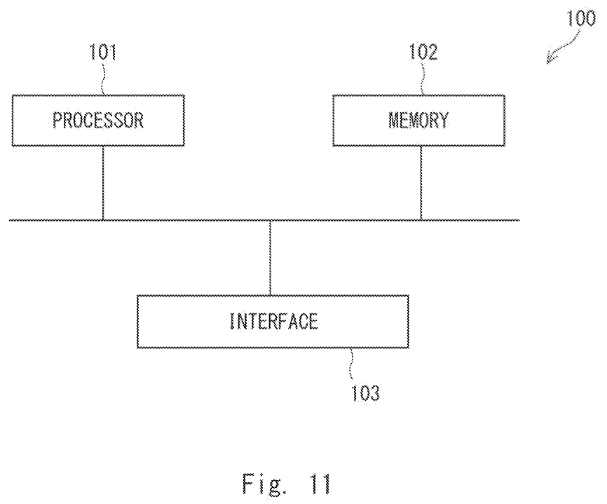

Further, each of the apparatuses provided in the conveyance system 1 according to the above-described embodiment may have, for example, the below-shown hardware configuration. FIG. 11 shows an example of a hardware configuration of such an apparatus.

The apparatus shown in FIG. 11 may include a processor 101, a memory 102, and an interface 103. The interface 103 may include interfaces with, for example, a drive unit, a sensor, an input/output device, and the like which are required according to the apparatus.

The processor 101 may be, for example, a microprocessor, an MPU (Micro Processor Unit), or a CPU. The processor 101 may include a plurality of processors. The memory 102 is composed of, for example, a combination of a volatile memory and a nonvolatile memory. The function of each apparatus is implemented by having the processor 101 load a program stored in the memory 102 and executing the loaded program while exchanging necessary information through the interface 103. That is, a part of or the whole processing performed by the host management apparatus 10, the environment camera 300, the mobile robot 20 and the like can be implemented as a computer program(s).

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present invention is not limited to the above-described embodiments, and they may be modified as appropriate without departing from the scope and spirit of the invention. For example, although a system in which conveyance robots autonomously move in a hospital has been described in the above-described embodiment, the above-described conveyance system can convey certain articles as luggage in a hotel, a restaurant, an office building, an event venue, or a complex facility.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A control system configured to:
perform system control for controlling a system including a plurality of cameras installed in a facility; and
perform a group classification process for recognizing a feature of a person photographed by the camera and classifying the person into a predetermined first group or a predetermined second group based on the feature, wherein
in the system control,
the control system selects a first operation mode when there is a person belonging to the first group, and selects a second operation mode different from the first operation mode when there is no person belonging to the first group, and
when the control system selects the second operation mode, the control system performs the group classification process so as to make either one of the number of cameras to be operated among the plurality of cameras and the number of cameras used as an information source in classification in the group classification process among the plurality of cameras less than the number of cameras that are used when the first operation mode is selected.

2. The control system according to claim 1, wherein in the system control, the plurality of cameras are controlled so that the plurality of cameras are operated when the first operation mode is selected, and operations of the plurality of cameras except that of a first camera are stopped when the second operation mode is selected.

3. The control system according to claim 2, wherein the first camera includes a camera provided at a position for monitoring a security gate in the facility.

4. The control system according to claim 2, wherein
the system control includes control of a mobile robot configured to autonomously move in a predetermined area inside the facility,
the camera is provided at a position away from a surface on which the mobile robot travels so as to photograph a periphery of the traveling mobile robot, and
in the system control, the plurality of cameras are controlled so that the camera that functions as the first camera is changed according to a traveling position of the mobile robot.

5. The control system according to claim 1, wherein
the system control includes control of a mobile robot configured to autonomously move in a predetermined area inside the facility, and
the camera is provided at a position away from a surface on which the mobile robot travels so as to photograph a periphery of the traveling mobile robot.

6. The control system according to claim 1, wherein in the group classification process, the person is classified according to a feature of clothing of the person or according to whether or not the person carries a predetermined article.

7. A control method comprising:
performing system control for controlling a system including a plurality of cameras installed in a facility; and
performing a group classification process for recognizing a feature of a person photographed by the camera and classifying the person into a predetermined first group or a predetermined second group based on the feature, wherein
in the system control,
a first operation mode is selected when there is a person belonging to the first group, and a second operation mode different from the first operation mode is selected when there is no person belonging to the first group, and
when the second operation mode is selected, the group classification process is performed so that either one of the number of cameras to be operated among the plurality of cameras and the number of cameras used as an information source in classification in the group classification process among the plurality of cameras is made less than the number of cameras that are used when the first operation mode is selected.

8. The control method according to claim 7, wherein in the system control, the plurality of cameras are controlled so that the plurality of cameras are operated when the first operation mode is selected, and operations of the plurality of cameras except that of a first camera are stopped when the second operation mode is selected.

9. The control method according to claim 8, wherein the first camera includes a camera provided at a position for monitoring a security gate in the facility.

10. The control method according to claim 8, wherein
the system control includes control of a mobile robot configured to autonomously move in a predetermined area inside the facility,
the camera is provided at a position away from a surface on which the mobile robot travels so as to photograph a periphery of the traveling mobile robot, and
in the system control, the plurality of cameras are controlled so that the camera that functions as the first camera is changed according to a traveling position of the mobile robot.

11. The control method according to claim 7, wherein
the system control includes control of a mobile robot configured to autonomously move in a predetermined area inside the facility, and
the camera is provided at a position away from a surface on which the mobile robot travels so as to photograph a periphery of the traveling mobile robot.

12. The control method according to claim 7, wherein in the group classification process, the person is classified according to a feature of clothing of the person or according to whether or not the person carries a predetermined article.

13. A non-transitory computer readable medium storing a program for causing a computer to perform a control method, the control method comprising:
performing system control for controlling a system including a plurality of cameras installed in a facility; and
performing a group classification process for recognizing a feature of a person photographed by the camera and classifying the person into a predetermined first group or a predetermined second group based on the feature, wherein
in the system control,
a first operation mode is selected when there is a person belonging to the first group, and a second operation mode different from the first operation mode is selected when there is no person belonging to the first group, and
when the second operation mode is selected, the group classification process is performed so that either one of the number of cameras to be operated among the plurality of cameras and the number of cameras used as an information source in classification in the group classification process among the plurality of cameras is made less than the number of cameras that are used when the first operation mode is selected.

14. The non-transitory computer readable medium according to claim 13, wherein in the system control, the plurality of cameras are controlled so that the plurality of cameras are operated when the first operation mode is selected, and operations of the plurality of cameras except that of a first camera are stopped when the second operation mode is selected.

15. The non-transitory computer readable medium according to claim 14, wherein the first camera includes a camera provided at a position for monitoring a security gate in the facility.

16. The non-transitory computer readable medium according to claim 14, wherein
the system control includes control of a mobile robot configured to autonomously move in a predetermined area inside the facility,
the camera is provided at a position away from a surface on which the mobile robot travels so as to photograph a periphery of the traveling mobile robot, and
in the system control, the plurality of cameras are controlled so that the camera that functions as the first camera is changed according to a traveling position of the mobile robot.

17. The non-transitory computer readable medium according to claim 13, wherein
the system control includes control of a mobile robot configured to autonomously move in a predetermined area inside the facility, and
the camera is provided at a position away from a surface on which the mobile robot travels so as to photograph a periphery of the traveling mobile robot.

18. The non-transitory computer readable medium according to claim 13, wherein in the group classification process, the person is classified according to a feature of clothing of the person or according to whether or not the person carries a predetermined article.
